(19) United States
(12) Patent Application Publication
(10) Pub. No.: US 2008/0315703 A1
(43) Pub. Date: Dec. 25, 2008

(54) Stator Core for Alternator and Motor

(75) Inventor: Dong Choon Lee, Seoul (KR)

Correspondence Address: KEUSEY, TUTUNJIAN & BITETTO, P.C., 20 CROSSWAYS PARK NORTH, SUITE 210, WOODBURY, NY, 11797, US

(73) Assignee: KOREA SHIROYAMA CO., LTD., Daegu (KR)

(21) Appl. No.: 11/547,244

(22) PCT Filed: Sep. 9, 2004
(86) PCT No.: PCT/KR2004/002303

§ 371 Date: Sep. 10, 2008

(30) Foreign Application Priority Data
Apr. 7, 2004 (KR) 1020040023651

(51) Int. Cl. H02K 1/14; H02K 15/02

(52) U.S. Cl. 310/195; 29/596

(57) ABSTRACT

Disclosed is a stator core for a generator and a motor comprising a frame formed in a shape of a straight plate; and a plurality of coil winding portions spacedly formed in one side of the frame and projected from the one side thereof. The stator core forms a stator by bending the frame in a round shape so as to position the coil winding portions in an inner side of the frame, laminating the frame, and winding coils around the coil winding portions. Wherein projections are spacedly formed in the portions corresponding to the coil winding portions in the other side of the frame, and the projections compensates height differences generated on an outer wheel of the frame due to a plastic deformation that portions corresponding to grooves between the coil winding portions in the other side of the frame are projected when bending the frame in a round shape, thereby to maintain evenly a surface of the outer wheel of the frame.

### TECHNICAL FIELD

The present invention relates to a stator core for a generator and a motor which comprises a frame formed in a shape of a straight plate, and a plurality of coil winding portions spacedly formed in one side of the frame and projected from the one side thereof, and which forms a stator by bending the frame in a round shape so as to position the coil winding portions in an inner side of the frame, laminating the frame, and winding coils around the coil winding portions.

More particularly, the present invention relates to a stator core for a generator and a motor wherein height differences on an outer wheel of a frame of the stator core can be compensated by spacedly forming projections on portions corresponding to the coil winding portions in the other side of the frame thereof, because the height differences are generated due to a plastic deformation that portions located between coil winding portions of the frame are projected when the frame is bent in a round shape

### BACKGROUND ART

If generally looking around an inner structure of a typical motor, a stator is provided in the motor and a rotor having a rotation axis is rotationally engaged with an inner side of the stator.

The above-mentioned stator is magnetized by a power supply provided from the outside and generates torque to the rotor by repulsive power with the rotor. Typically, the stator is fabricated by bending a core 100 formed in a shape of a straight line as shown in FIG. 1, making the core in a round shape, laminating the core, and then winding a coil 200 in an inner side of the core as shown in FIG. 2.

As shown in FIG. 1, the core 100 comprises a frame 110 formed in a shape of a straight plate, and a plurality of coil winding portions 120 projected and formed in a shape of “T” on one side of the frame 110 for winding the coils around the coil winding portions. Then, the other side of the frame 110 is formed in a shape of a straight line.

However, in a case of the stator core for a motor according to the prior art constructed as mentioned above, if the frame is bent in a round shape such that the coil winding portions are positioned in the inner side thereof, portions corresponding to grooves between the coil winding portions on an outer wheel of the frame are projected outside in view of an essential property of plastic deformation as shown in FIG. 2, and thus height differences on the outer wheel of the frame are generated.

Consequently, even in a case of the stator provided by laminating the cores according to the prior art and winding the coils around the coil winding portions, because height differences on the outer wheel of the frame are generated, an additional surface processing should be carried out for suppressing a generation of such height differences therein by abrading the portions projected from the outer wheel of each of the cores in order to correctly install the stator in a housing of the motor. As a result, a problem that time and cost should be additionally consumed has arisen.

### DISCLOSURE OF THE INVENTION

Accordingly, the present invention is intended to solve the above disadvantages associated with the prior art. It is an object of the present invention to provide a stator core for a generator and a motor wherein height differences generated on an outer wheel of a frame of the stator core when the frame is bent in a round shape are compensated by projections which are spacedly formed in the portions corresponding to the coil winding portions in the other side of the frame of the stator core, and thus a surface of the outer wheel of the frame cam be evenly maintained.

In order to accomplish the above-mentioned object of the invention, a stator core for a generator and a motor according to the present invention comprises a frame formed in a shape of a straight plate; and a plurality of coil winding portions spacedly formed in one side of the frame and projected from the one side thereof; wherein the stator core forms a stator by bending the frame in a round shape so as to position the coil winding portions in an inner side of the frame, laminating the frame, and winding coils around the coil winding portions, and wherein projections are spacedly formed in the portions corresponding to the coil winding portions in the other side of the frame, the projections compensating height differences generated on an outer wheel of the frame due to a plastic deformation that portions corresponding to grooves between the coil winding portions in the other side of the frame are projected when bending the frame in a round shape, thereby to maintain evenly a surface of the outer wheel of the frame.

### BRIEF DESCRIPTION OF THE DRAWINGS

FIG. 1 is a plan view of stator cores for a motor according to the prior art.

FIG. 2 is a plan view of a stator for the motor in which the cores shown in FIG. 1 are laminated.

FIG. 3 is a plan view of stator cores for a motor according to an embodiment of the present invention.

FIG. 4 is a plan view of a stator for the motor in which the cores shown in FIG. 3 are laminated.

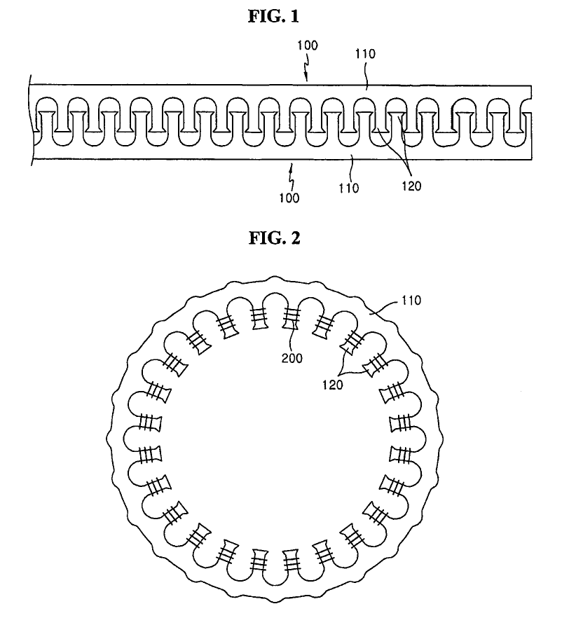

### BEST MODES FOR CARRYING OUT THE INVENTION

Features of the construction and the operation of the present invention will be described in detail below through the preferred embodiments of stator cores for a generator and a motor according to the present invention. Herein, because the stator cores according to the present invention are equally applied to a generator and a motor, only an embodiment of the motor will be described.

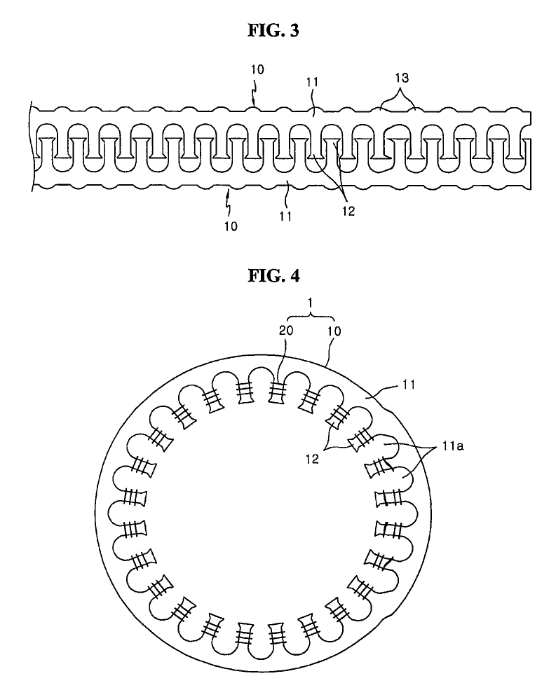

FIG. 3 among the drawings attached hereto is a plan view of stator cores for a motor according to an embodiment of the present invention and FIG. 4 is a plan view of a stator for the motor in which the cores shown in FIG. 3 are laminated.

As shown in FIG. 3, the stator core 10 for a motor according to an embodiment of the present invention comprises a frame 11 formed in a shape of a straight plate, and a plurality of coil winding portions 12 projected and formed in one side of the frame 11 such that the coil winding portions are spaced each other.

Then, projections 13 are spacedly formed in the portions corresponding to the coil winding portions 12 in the other side of the frame 11.

In case that the frame 11 is bent in a round shape, portions corresponding to grooves 11a between the coil winding portions 12 in the other side of the frame 11 will be projected outside in view of an essential property of plastic deformation.

However, as mentioned above, because projections 13 are formed between the portions projected by the plastic deformation, that is, on the portions corresponding to the coil winding portions 12 in the other side of the frame 11, height differences on an outer wheel of the frame 11 are not generated.

That is, as the projections 13 compensate the height differences on the outer wheel of the frame generated upon plastic deformation, an outer wheel of the core 10 according to the present invention can be even without the height differences as can be seen in FIG. 4.

Furthermore, because an outer wheel of the stator 1 in which the cores 10 according to the present invention are laminated is also even without the height differences as shown in FIG. 4, the stator 1 can be fixedly installed easily and correctly in the housing of the motor without carrying out a process for processing a surface of an outer wheel of a stator like the prior art.

Meanwhile, the coil winding portions 12 is formed in a shape of “T” and radially positioned upon bending of the frame 11.

Then, operations of the stator cores for the motor according to an embodiment of the present invention as constructed above will be described below.

Firstly, by pressing an iron plate through a press process, a pair of the stator core 10 according to the present invention as shown in FIG. 3 can be prepared. Then, the frame 11, the coil winding portions 12 and the projections 13 of each of the core 10 are integrally formed.

Like this, by bending the core 10 in a round shape, joining both ends of the core, laminating cores, and then winding coils 20 around the coil winding portions 12 after the stator core 10 according to the present invention is prepared, the stator 1 for the motor is accomplished.

The stator 1 for the motor is constructed such that, by laminating the cores 10 at a certain height according to specific types of motors and winding the coils 20 around the coil winding portions 12 which are radially projected from inner wheel of the stator, the stator is magnetized by a power source applied to the coil 20 from an outside, the rotor which is rotationally engaged in a center thereof is rotated and then the motor is operated.

If the core 10 according to the embodiment of the present invention is bent in a round shape, because of the projections 13 which are formed in the portions corresponding to the coil winding portions 12 in the other side of the frame 11, the outer wheel of the frame can be equally maintained without height differences thereon.

Therefore, in a process of fixedly installing the stator 1 in which the cores 10 according to the embodiment of the present invention are laminated in the housing of the motor, because the surface of the stator 1 is smoothly formed nearly to the perfect circle without height differences thereon, the stator 1 can be easily and correctly installed in the housing of the motor without carrying out a separate process of the surface thereof.

As mentioned above, while the stator core for the motor according to the preferred embodiment of the present invention has been described with reference to the drawings attached hereto, it is to be understood that the present invention should not be limited to the embodiments and drawings herein and various modifications may be made without deviating from the scope of the concept of the present invention. In particular, it should be intended that the stator core according to the present invention is equally applied for generators as well as motors, and these embodiments are also included in the scope of the claim of the present invention.

### INDUSTRIAL APPLICABILITY

As mentioned above, according to the stator core for the generator and the motor, since the outer wheel of the frame can be evenly maintained without height differences thereon because of the projections which are formed in the portions corresponding to the coil winding portions in the other side of the frame, as the surface of the stator is also smoothly formed nearly to the perfect circle without height differences thereon in a process of fixedly installing the stator in which the cores according to the present invention are laminated in the housing of the generator or the motor, that is, the roundness thereof is precise, the stator can be easily and correctly installed in the housing of the motor or the generator without carrying out a separate process of the surface thereof.

Furthermore, because the stator is fixedly installed correctly in the housing of the motor or the generator, a space between the stator and the rotor is uniform as the roundness of the inner side of the stator is precise, and thus, the performance of the generator and the motor can be improved.

In addition, because the roundness of the outer side of the stator is precise, as the contact area of the stator and the rotor is enlarged, heat radiation effect thereof can be increased, and thus, problems due to amplification of the temperature can be decreased. Consequently, the life duration of the generator and the motor can be extended and the performance thereof can also be improved.

Moreover, because the roundness of the outer side of the stator is precise, the deviation of thickness of the stator is not generated unlike the prior art and thus the tensile force by heat is uniformly generated. Thus, the stability in the production and performance of the generator and the motor can be secured.

1. A stator core for a generator and a motor, comprising:
a frame formed in a shape of a straight plate; and
a plurality of coil winding portions spacedly formed in one side of the frame and projected from the one side thereof;
wherein the stator core forms a stator by bending the frame in a round shape so as to position the coil winding portions in an inner side of the frame, laminating the frame, and winding coils around the coil winding portions, and
wherein projections are spacedly formed in the portions corresponding to the coil winding portions in the other side of the frame, the projections compensating height differences generated on an outer surface of the frame due to a plastic deformation that portions corresponding to grooves between the coil winding portions in the other side of the frame are projected when bending the frame in a round shape, thereby evenly maintaining the outer surface of the frame.

2. A method for forming a stator core for a generator and a motor, comprising:
forming a frame in a shape of a straight plate where a plurality of coil winding portions are spacedly formed in one side of the frame and projected from the one side thereof, wherein projections are spacedly formed in the portions corresponding to the coil winding portions in the other side of the frame, the projections compensating height differences generated on an outer surface of the frame due to a plastic deformation that portions corresponding to grooves between the coil winding portions in the other side of the frame are projected when bending the frame in a round shape, thereby evenly maintain a surface of the outer wheel of the frame;
bending the frame in a round shape so as to position the coil winding portions in an inner side of the frame;
laminating the frame; and
winding coils around the coil winding portions.
